(19) United States
(12) Patent Application Publication
(10) Pub. No.: US 2006/0137355 A1
(43) Pub. Date: Jun. 29, 2006

(54) Fan driven emergency generator

(75) Inventors: Richard Welch, Rockford, IL (US); Jose Albero, Lachenaie (CA); Gerard Bueche, Byron, IL (US); William Degroff, Byron, IL (US); Jerzy Makuszewski, Mississauga (CA)

Correspondence Address: BACHMAN & LAPOINTE, P.C., 900 CHAPEL STREET, SUITE 1201, NEW HAVEN, CT, 06510, US

(73) Assignee: Pratt & Whitney Canada Corp.

(21) Appl. No.: 11/020,163

(22) Filed: Dec. 27, 2004

(51) Int. Cl. F02C 7/32

(52) U.S. Cl. 60/772; 60/802

(57) ABSTRACT

An emergency electrical power generating apparatus for use with a turbofan engine comprises an electrical generator and a clutch assembly. The clutch connects the generator with a fan assembly of the engine only during a windmill action of the fan assembly.

### TECHNICAL FIELD

The invention relates generally to an aircraft generator and, more particularly, to an improved emergency electrical power generating apparatus for use with an aircraft gas turbine engine having a fan assembly.

### BACKGROUND OF THE ART

In modern turbofan powered aircraft, an emergency power source is required for control of flight surfaces in the event of total loss of the availability of the primary power sources, i.e. engine driven hydraulic pumps and/or engine driven electrical generators. In small airplanes this power is provided by the energy stored in aircraft batteries. In larger airplanes, a single ram air turbine, or RAT with an integral generator or hydraulic pump is provided for deployment in emergency situations only. The emergency power source is the aircraft's own air speed (kinetic energy) and altitude (potential energy). However, a RAT must be positioned away from the aircraft surfaces and is usually mounted under the wing or below the nose of the aircraft. It can present significant challenges in aircraft design to find a suitable location for the RAT and to design a deployment system to position on the RAT for deploying same into the air stream. In order to avoid those challenges and other disadvantages of RAT systems, emergency electrical generators coupled with a low pressure spool of engines, have been developed to use the kinetic energy and potential energy provided by the fan assembly of the engine, during a windmill action thereof. Nevertheless, the conventional fan-driven emergency generator systems are not satisfactory for various reasons.

Accordingly, there is a need to provide an improved fan-driven emergency electrical power generating apparatus and a method for use of same with aircraft turbofan engines.

### SUMMARY OF THE INVENTION

It is therefore an object of this invention to provide an emergency electrical power generating apparatus and a method for use with an aircraft gas turbine engine having a fan assembly.

In one aspect, the present invention provides an emergency electrical power generating apparatus for use with an aircraft gas turbine engine having a fan assembly, which comprises an electrical generator and a clutch assembly for connecting the electrical generator with the fan assembly to transfer torque from the fan assembly during a windmill action of the fan assembly, and for disconnecting the generator from the fan assembly during engine operation.

In another aspect, the present invention provides an emergency electrical power generating apparatus for use with an aircraft gas turbine engine having a fan assembly, which comprises an electrical generator stator mounted to a housing of a bearing, and an electrical generator rotor mounted to one of a fan shaft and a low pressure spool shaft supported directly on said bearing.

In another aspect, the present invention provides a method for generating emergency electrical power using a windmill action of an aircraft gas turbine engine, which comprises disconnecting torque transmission from the engine to an emergency electrical power generator during engine operation; and connecting torque transmission from the engine to the emergency electrical power generator during the windmill action.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a schematic illustration of a turbofan engine in a cross-sectional view, incorporating one embodiment of the present invention in which an emergency electrical power generating apparatus is positioned within an engine tailcone compartment;

FIG. 2 is a schematic illustration of an alternative arrangement of the embodiment of FIG. 1;

FIG. 3 is a schematic illustration of another embodiment of the present invention, in which the emergency electrical power generating apparatus is engine core mounted on a tower shaft;

FIG. 4 is a schematic illustration of a further embodiment of the present invention, in which an emergency generator is incorporated with the Number 1 bearing of the engine; and

FIG. 5 is an alternative arrangement of the embodiment of FIG. 4.

### DETAILED DESCRIPTION OF THE PREFERRED EMBODIMENTS

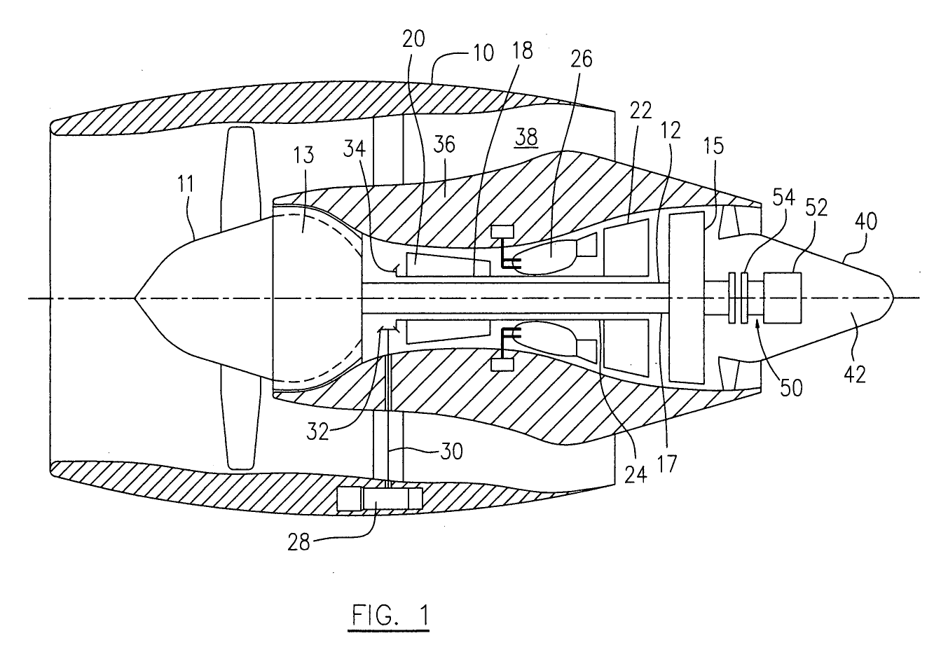

FIG. 1 schematically illustrates a turbofan engine which incorporates an embodiment of the present invention to illustrate, as an example, the application of the present invention. The turbofan engine of FIG. 1 includes a housing or nacelle 10, a low pressure spool assembly seen generally at 12 which includes a fan assembly 11, low pressure compressor 13, low pressure turbine 15 and low pressure spool shaft 17 connecting the low pressure compressor 13 with the low pressure turbine 15, a high pressure spool assembly seen generally at 18 which includes a high pressure compressor 20, high pressure turbine 22 and high pressure spool shaft 24 connecting the high pressure compressor 20 with the high pressure turbine 22. The engine further comprises a burner seen generally at 26 and an accessory drive assembly seen generally at 28 which is coupled to the high pressure spool shaft 24 through a tower shaft 30 and a pair of bevel gears 32, 34.

An engine core casing 36 is provided to support the low pressure and high pressure spool assemblies 12 and 18, thereby defining an annular main fluid path of the engine therethrough and an annular bypass duct 38 between the nacelle 10 and the engine core casing 36. A tailcone 40 is provided at the aft end of the engine core casing 36 for directing exhaust gases discharged from the aft end of the engine core casing 36. The tailcone 40 defines a tailcone compartment 42 therein which accommodates an emergency electrical power generating apparatus 50 according to one embodiment of the present invention.

The emergency electrical power generating apparatus 50 includes an electrical generator 52 coupled with a clutch assembly 54 at an output end thereof and the clutch assembly 54 at an input end thereof is coupled with the low pressure spool shaft 17. Thus, the electrical generator 52 is driven to rotate by torque transmitted from the low pressure spool shaft 17 when the clutch assembly 54 is engaged. The electrical generator 52 is not in operation when the clutch assembly 54 is disengaged.

Selective engagement of the clutch assembly 54 is arranged to meet requirements such that during normal engine operating conditions the clutch assembly 54 is disengaged to disconnect the generator from the low pressure spool shaft 17, and during a windmill action of the fan assembly 11 when the engine has failed to function, the clutch assembly 54 is engaged to connect the electric generator with the low pressure spool shaft 17. The low pressure spool shaft 17 is coupled with the fan shaft (not shown) and is rotated together with the fan assembly 11, thereby transferring torque from the fan assembly 11 to the electrical generator 52 during the windmill action. Therefore, the electrical generator 52 is only operated to provide emergency electrical power to the aircraft in emergency situations in which the engine has failed to function.

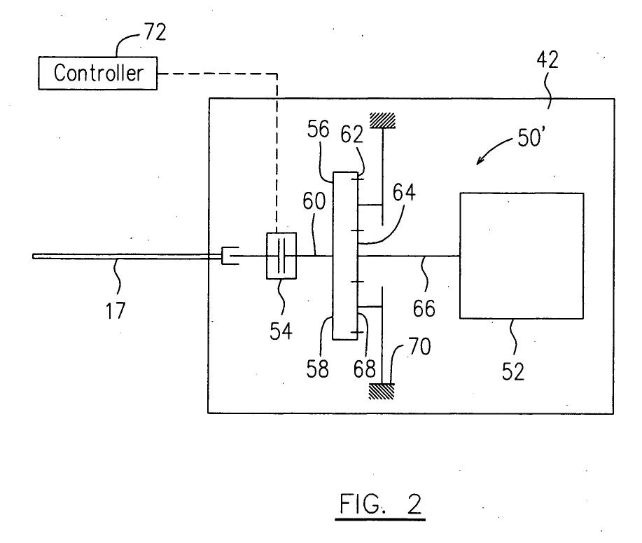

FIG. 2 schematically illustrates an alternative arrangement of the embodiment of FIG. 1. The emergency electrical power generating apparatus according to the alternatively arranged embodiment as shown in FIG. 2, which is generally indicated as 50′ and is similar to emergency electrical power generating apparatus 50, is also positioned within the tailcone compartment 42. Apparatus 50′ includes electrical generator 52 which is coupled to the clutch assembly 54 at the output end thereof, through a speed increasing gearset 56. The gearset 56 advantageously increases the rotational speed of the electrical generator 52 when the clutch assembly 54 connects the electrical generator 52 with the low pressure spool shaft 17, during a windmill action of the fan assembly 11 of FIG. 1. With such a high operative speed, the electrical generator 52 can be designed in a compact configuration to achieve the electrical power generating capacity required for emergency situations.

The speed increasing gearset 56 can be any type of gearbox configuration. As a preferred example, the gearset 56 as illustrated in FIG. 2, includes a plate 58 at one side thereof having a central shaft 60 coupled with the output end of the clutch assembly 54. The plate 58 includes an inner gear ring 62 extending circumferentially around the periphery thereof. At the other side of the gearset 56, a small central gear 64 is provided with a central shaft 66 which is coupled with the electrical generator 52. The central gear 64 is positioned coaxially with plate 58 and gears into the inner gear 62 of the plate 58 through a pair of idle gears 68. The idle gears 68 are rotatably supported by a stationary structure 70 of the tailcone compartment 42. The speed increasing gearset 56 having such a described configuration, can advantageously provide a relatively high speed increasing ratio while maintaining a very compact configuration, which fits into the engine tailcone compartment 42. However, any known type of speed increasing gearbox can be used to replace the speed increasing gearset 56.

Referring to FIGS. 1 and 2, clutch assembly 54 advantageously provides a selective operation of the electrical generator 52 such that the emergency electrical power generating apparatus 50, 50′ is operated only during a windmill action when an emergency situation arises, and avoids unnecessary operation during normal engine operation. This will extend the lifespan of the electrical generator 52 and ensure the working condition thereof in emergency situations, which is more apparent when speed increasing gearset 56 is included, as illustrated in FIG. 2.

The speed increasing ratio of the speed increasing gearset 56 is generally designed to increase the operative speed of the electrical generator 52 from a relatively low rotational speed of the low pressure spool shaft 17 during a windmill action of the fan assembly 11. Under normal engine operating conditions, however, the fan assembly 11 and the low pressure spool 12 are rotated by the low pressure turbine 15 at a rotational speed much higher than the rotational speed of the low pressure spool shaft 17 during a windmill action of the fan assembly 11. If the emergency electrical power generating apparatus 50′ did not include clutch assembly 54 and the speed increasing gearset 56 was directly coupled to the low pressure spool shaft 17, speed increasing gearset 56 would drive the electrical generator 52 at a rotational speed much higher than the required operative speed of the electrical generator 52. It is therefore desirable to avoid unnecessary operation of the electrical generator 52 under such overspeed conditions.

Various types of clutch assemblies can be used, for example, clutch assembly 54 can be a centrifugal clutch, which is disengaged to disconnect the electrical generator 52 from the low pressure spool shaft 17 when the input side of the clutch assembly 54 coupled with the low pressure spool shaft 17 is rotated at a higher rotational speed range under normal engine operating conditions, and which is engaged to connect the electrical generator 52 to the low pressure spool shaft 17 when the input end of the clutch assembly 54 coupled with the low pressure spool shaft 17 is rotated at a low speed range during a windmill action of the fan assembly 11. The centrifugal clutch is automatically controlled by the change in input speed. However, the component indicated by numeral 54 in either FIG. 1 or FIG. 2, does not represent any particular structural configuration of the clutch assembly, but is only a symbolic indication of the clutch assembly.

The clutch assembly 54 can be various other types of clutch which can be controlled manually, or automatically such as being electrically or hydraulically controlled by a controller 72, as shown in FIG. 2. Controller 72 can be an independent controller or can be incorporated as a part of the engine electrical controller (EEC). When an emergency situation arises and a windmill action of the fan assembly occurs, the clutch assembly 54 which is usually disengage during flight, will be activated manually or automatically by the controller 72, to connect the electrical generator 52 with or without the speed increasing gearset 56, to the low pressure speed shaft 17.

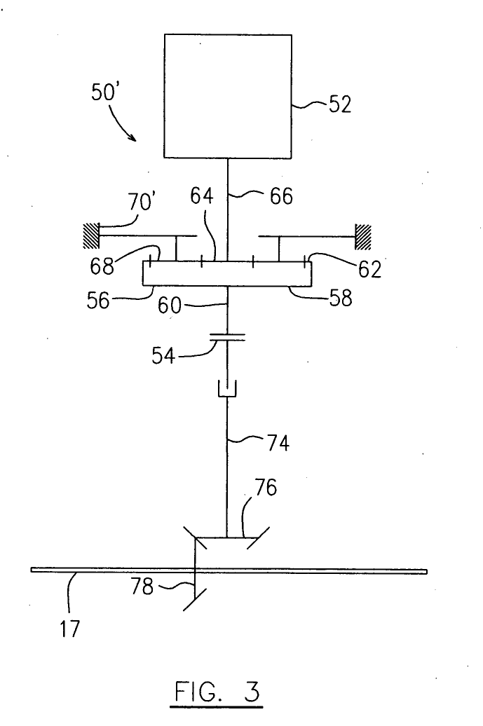

FIG. 3 illustrates a further embodiment of the present invention in which components similar to those in FIGS. 1 and 2 and indicated by similar numerals will not be redundantly described. The emergency electrical power generating apparatus 50′ according to the embodiment shown in FIG. 3, is mounted to the engine core casing 36 of FIG. 1, and the idle gears 68 of the speed increasing gearset 56 are rotatably supported by a stationary structure 70′ of the engine core casing 36 of FIG. 1. The input end of the clutch assembly 54 is coupled to the low pressure spool shaft 17 through a tower shaft 74 and a pair of bevel gears 76, 78. The tower shaft 74 is positioned and configured similarly to the tower shaft 30 of FIG. 1. The difference between tower shaft 74 and tower shaft 30 of FIG. 1, lies in that tower shaft 30 of FIG. 1 is coupled with high pressure spool shaft 24 and extends through the bypass duct 38 to the accessory gearbox 28 mounted in the nacelle 10, while tower shaft 74 is coupled to the low pressure spool shaft 17 and extends only to the emergency electrical power generating apparatus 50′ mounted on the engine core casing 36 of FIG. 1 and does not extend through the annular bypass duct 38 of FIG. 1. Tower shaft 30 of FIG. 1 cannot be coupled with the emergency electrical power generating apparatus 50′ because a windmill action drives only the fan assembly 11 and the coupled low pressure spool shaft 17 and does not drive the high pressure spool shaft 24 to which the tower shaft 30 of FIG. 1 is coupled.

The emergency generator does not absolutely need to be in the engine core location. An alternative configuration could have the unit mounted inside the nacelle on the fan case area (same general location as the accessory gearbox). In this arrangement the towershaft would extend through a strut and into the nacelle area to the clutch generator unit.

In the embodiment of FIG. 3, the clutch assembly 54 and the speed increasing gearset 56 can also be selected from various types, as discussed with reference to the previous embodiments.

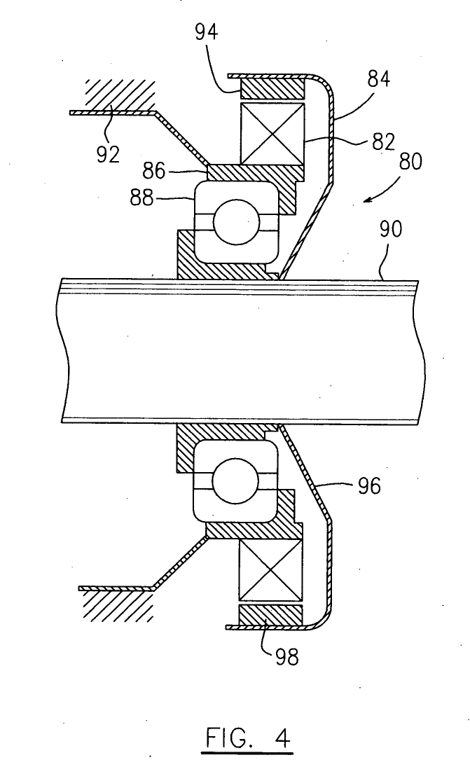

FIG. 4 schematically illustrates a still further embodiment of the present invention in which an emergency electrical power generating apparatus 80 includes an electrical generator stator 82 and an electrical generator rotor 84. The electrical generator stator 82 which includes at least one, but preferably a plurality of electrical windings (not indicated), is mounted to a housing 86 of the Number 1 bearing 88 of the engine. The Number 1 bearing 88 is used to directly support a fan shaft 90 of the fan assembly 11 of FIG. 1, with the housing 86 thereof supported by a stationary structure 92 of the engine core casing 36 of FIG. 1. The fan shaft 90 is coupled with the low pressure spool shaft 17 of FIG. 1 and is rotatable together with same.

The electrical generator rotor 84 includes at least one, but preferably a plurality of permanent magnets 94 attached to an annular support member 96. The annular support member 96 is mounted at an inner periphery thereof on the fan shaft 90, and has an axially extending flange 98 for the attachment of the permanent magnets 94 thereto such that the permanent magnets 94 are positioned around and slightly radially spaced apart from the electrical generator stator 82. Thus, the electrical generator stator 82 and rotor 94 in combination form an electrical generator incorporated with the Number 1 bearing assembly.

It should be noted that the configuration of the electrical generator stator 82 and rotor 94 including the annular support member 96, are examples to illustrate the configuration of an electrical generator incorporated with a bearing assembly. The stator and rotor of the electrical generator incorporated with a bearing assembly according to this invention may have alternative structural arrangements. For example, stators may include permanent magnets and rotors may include electric windings. Furthermore, the annular support member 84 can be replaced by other configurations which have substantially similar functions for supporting the rotor in the operative position and transmitting torque to the rotor.

It also should be noted that according to the present invention, the emergency electrical power generating apparatus 80 can be incorporated with any bearing assemblies which directly support one of the fan shaft and low pressure spool shaft of a gas turbine engine having a fan assembly.

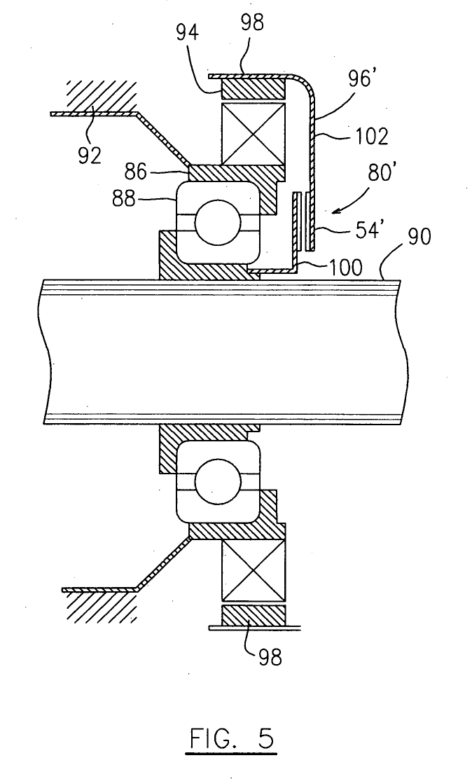

FIG. 5 schematically illustrates an alternative arrangement of the embodiment of FIG. 4. An emergency electrical power generating apparatus having an alternative structural arrangement is generally indicated by 80′. The apparatus 80′ has components and features similar to those of apparatus 80 of FIG. 4, and the only difference therebetween lies in that the configuration of apparatus 80′ embodies an annular support member 96′ incorporated with a clutch assembly 54′. The annular support member 96′ is divided into two separate portions. An inner portion 100 which is mounted on the fan shaft 90 is connected to an input end (not indicated) of the clutch assembly 54′, and an outer portion 102 which has the axially extending flange 98 for attachment of the permanent magnets 94, is connected to the output end of the clutch assembly 54′.

It should be noted that similar to the clutch assembly 54 described in the other embodiments and illustrated in FIGS. 1-3, clutch assembly 54′ illustrated in FIG. 5 is a symbolic indication only to illustrate the function thereof for selectively connecting and disconnecting the permanent magnets 94 (the rotors) to and from the fan shaft 90. The illustration of the clutch assembly 54′ does not indicate any particular structural configuration thereof. Similarly to clutch assembly 54, many variations of clutch assemblies can be applicable for the clutch assembly 54′, which will not be repeated herein.

The addition of clutch assemblies 54 and 54′ to the emergency electrical power generating apparatuses 50, 50′, 80 and 80′, further advantageously provides an option to allow testing of the emergency electrical power generating apparatus during engine start up, in which the fan shaft and the low pressure spool are driven by the low pressure turbine at a low rotational speed range similar to that provided by a windmill action in an emergency situation. Once the engine is accelerated above this rotational speed range, the clutch assemblies will disconnect the emergency electrical power generating apparatus from the operative engine and thereby discontinue the testing procedure.

The above description is meant to be exemplary only, and one skilled in the art will recognize that changes may be made to the embodiments described without departing from the scope of the invention disclosed. For example, emergency electrical generator may be replaced by an emergency hydraulic pump, or the present invention can be applicable to an aircraft engine having propellers. Still other modifications which fall within the scope of the present invention will be apparent to those skilled in the art, in light of a review of this disclosure, and such modifications are intended to fall within the scope of the appended claims.

1. An emergency electrical power generating apparatus for use with an aircraft gas turbine engine having a fan assembly, comprising:
an electrical generator; and
a clutch assembly for connecting the electrical generator with the fan assembly in order to transfer torque from the fan assembly during a windmill action of the fan assembly, and for disconnecting the generator from the fan assembly during engine operation.

2. The apparatus as claimed in claim 1 further comprising a speed increasing gearset to provide a high rotational speed to the electrical generator.

3. The apparatus as claimed in claim 2 wherein the gearset is positioned between the clutch assembly and the electrical generator.

4. The apparatus as claimed in claim 1 wherein the clutch assembly connects and disconnects the electrical generator to and from a low pressure spool shaft.

5. The apparatus as claimed in claim 4 wherein the generator is positioned in an engine tailcone compartment.

6. The apparatus as claimed in claim 4 wherein the clutch assembly connects and disconnects the electrical generator to and from a low pressure spool shaft through a tower shaft.

7. The apparatus as claimed in claim 1 wherein the electrical generator comprises a stator mounted to a bearing housing of the fan assembly and wherein the electrical generator comprises a rotor mounted to a fan shaft through the clutch assembly, for selectively controlling operation of the electrical generator.

8. An emergency electrical power generating apparatus for use with an aircraft gas turbine engine having a fan assembly, comprising:
an electrical generator stator mounted to a housing of a bearing;
an electrical generator rotor mounted to one of a fan shaft and a low pressure spool shaft, supported directly on said bearing.

9. The apparatus as claimed in claim 8 wherein said bearing is Number 1 bearing of the engine for supporting the fan shaft.

10. The apparatus as claimed in claim 9 wherein the electrical generator stator comprises at least one electrical winding and wherein the electrical generator rotor comprises at least one permanent magnet.

11. The apparatus as claimed in claim 10 wherein the electrical generator rotor further comprises an annular support member mounted on the fan shaft for supporting the at least one permanent magnet in an operative position with respect to the at least one electrical winding.

12. A method for generating emergency electrical power using a windmill action of an aircraft gas turbine engine, comprising:
disconnecting torque transmission from the engine to an emergency electrical power generator during engine operation; and
connecting torque transmission from the engine to the emergency electrical power generator during the windmill action.

13. The method as claimed in claim 12 wherein the connecting and disconnecting of torque transmission are conducted by a clutch.

14. The method as claimed in claim 13 wherein the clutch is activated by a centrifugal force being applied thereon.

15. The method as claimed in claim 13 wherein the clutch is manually activated.

16. The method as claimed in claim 13 wherein the clutch is controlled by a controller.
